(19) United States
(12) Patent Application Publication
(10) Pub. No.: US 2026/0117796 A1
(43) Pub. Date: Apr. 30, 2026

(54) STEAM COMPRESSOR

(71) Applicant: TURBODEN S.P.A., Brescia (IT)

(72) Inventors: Roberto Bini, Brescia (IT); Mario Gaia, Brescia (IT); Gabriele Mariotti, Brescia (IT)

(73) Assignee: TURBODEN S.P.A., Brescia (IT)

(21) Appl. No.: 19/372,544

(22) Filed: Oct. 29, 2025

(30) Foreign Application Priority Data
Oct. 29, 2024 (IT) 102024000024177

(51) Int. Cl. F04D 29/58; F04D 17/12; F04D 29/42

(52) U.S. Cl. CPC F04D 29/5846; F04D 17/12; F04D 29/4206

(57) ABSTRACT

A steam compressor, specifically a multistage centrifugal compressor which could have an operating pressure between 0.2 bar and 12 bar and be used in industrial processes with heat pumps or for the mechanical compression of steam in general.

The present invention is to improve the state of the art for steam compressors by means of an optimized architecture that minimizes the manufacturing cost, such that it makes it comparable to that of a fan, without compromising its typical performance.

### BACKGROUND OF THE INVENTION

### 1. Field of the Invention

The present invention relates to a steam compressor, specifically a multistage centrifugal compressor. More specifically, the compressor according to the present invention could have an operating pressure between 0.2 bar and 12 bar and be used in industrial processes with heat pumps or for the mechanical compression of steam in general.

### 2. Brief Description of the Prior Art

Mechanical vapor compression, often referred to by its acronyms in english MVR (Mechanical Vapor Recompressor) or MVC (Mechanical Vapor Compression), involves compressing a vapor flow to raise its pressure and, possibly, its temperature, by means of a positive displacement machine or a turbomachine. The latter ones increase the vapor pressure by increasing the energy imparted to the fluid by one or more impellers driven by a prime mover. In this process, the vapor increases its enthalpy content, resulting in an increase in both pressure and temperature.

As is known, the pressure head, or the specific energy required to compress a vapor, and consequently the power absorbed by the machine, is proportional to its temperature. For this reason, multistage compressors and fans are often used in vapor compression, for example with multiple impellers, equipped with devices to cool the vapor flow, such as exchangers or interphase attemperators (also called desuperheaters), to reduce the vapor temperature and consequently the compression power. Specifically, attemperators can be realized by injecting liquid water, which, upon evaporation, reduces the temperature of the superheated fluid by exploiting its latent heat of vaporization.

Compressors with such attemperation systems are divided depending on whether the water injection is carried out in the piping system connecting the various compression stages or directly inside a compression stage.

Documents EP4170186A1 from Siemens Energy, CN111749932A from the China Institute of Aerodynamics, or CN107559239B from Beijing University describe the state of the art for the construction of spray-based attemperation systems within the compression stage, specifically with injection performed immediately upstream of the first compressor impeller. This solution is also widely used when compression is performed by centrifugal fans, also known as fans or blowers.

Other systems involve attempering by means of suitable de-superheaters installed on the pipes that fluidly connect each compression stage. These include sprayers mounted as shown in FIG. 1, taken from the catalogue of the Schutte & Koerting company, a manufacturer of steam attempering systems.

Water injection, according to a known technique, is dosed to reduce the degree of superheat until conditions approaching saturation are reached. Generally, this practice results in a non-optimal design of the compressor and/or the piping system, as any excess condensate, for example generated by sudden changes in the flow rate to be attempered, is dragged by the vapor liquid flow into the compressor impeller, causing erosion or vibrations. If liquid water is injected immediately upstream of the impeller, liquid entrainment occurs regardless of the dose due to the liquid's passage times through the impeller, which in common practice are always shorter than the evaporation times.

The erosion and vibration problems mentioned above are generated by the tangential forces due by the presence of liquid in the air gap between the rotating parts and their stators. It is known, in fact, that the contact of liquid water with the compressor impeller, having a peripheral velocity in the order of 200-400 m/s, induces strong tangential forces related to the viscous nature of the fluid and the velocity gradient to which it is subjected. The presence of liquid between a rotating part and its stator requires a significant increase in the air gap from a value of a few tenths to 3-5 mm (typical value used for fans) to avoid erosion and vibration, with obvious negative consequences on the stage's performance. It is known, in fact, that the efficiency of a centrifugal stage is negatively affected by the recirculation generated in the air gap between the impeller and stator parts, such as the casing or diaphragms.

By injecting water onto the pipeline, it is possible to optimize the efficiency of the stage by reducing the air gap between the impeller and the rotor, ensuring that all the injected water evaporates before it reaches an impeller. The evaporation of the injected water occurs with a delay, also called residence time, which determines the length of the pipe, depending on the velocity of the steam in the pipeline. Generally, this length is much greater than the minimum length needed to connect two consecutive stages, with obvious disadvantages in terms of cost, compactness, and pressure drops. In any case, to ensure that no liquid water is entrained in the impeller, it is necessary to dose the quantity of liquid water by considering a margin compared to the exact amount needed to achieve saturation of the steam flow. Alternatively, special separators, such as inertial separators, can be used on the pipeline, with obvious disadvantages in terms of performance and cost.

Another unique characteristic of steam compressors is the need to use materials resistant to general corrosion, such as stainless steel and aluminum alloys. This requirement is particularly stringent in the food industry when the steam produced comes into direct contact with food (e.g., sugar evaporation/concentration). The use of relatively expensive materials such as stainless steel to manufacture compressor components in contact with the steam penalizes the cost of compressors designed according to a traditional design, as shown in FIG. 2 from the API 617 standard. In these machines, the compressor casing is typically designed for “rigidity” to allow for minimal variation in the clearance between the impeller and the diaphragm, which can thus be reduced to values in the order of a few tenths of a millimeter. This solution leads to an increase in weight and cost compared to solutions where the rigidity requirement is not present, for example, when steam compression is performed by centrifugal fans, where the clearance between the impeller and stator is a few millimeters. A typical cross-sectional drawing of a fan is shown in FIG. 3.

It can be noted that the centrifugal fan has a much simpler, lighter, and more flexible casing than a typical compressor. This is due to the absence of a diffuser diaphragm and, in general, the absence of static parts mounted near the impeller, which is of the covered or “shrouded” type, where the minimum clearance with the stator is an order of magnitude greater than the typical clearance between the impeller and casing of a compressor.

The advantages of simplicity and cost-effectiveness of a centrifugal fan configuration are coupled with lower thermodynamic performance compared to those of a compressor, due to the high internal recirculation between the impeller and stator and the inability to develop high pressure heads per every stage, caused by the presence of a covered impeller. It is known that the presence of the cover, necessary on fans due to the lack of a stator diaphragm connected to the casing, induces stress on the impeller blades produced by the mass of the cover subjected to centrifugal acceleration.

Due to the relatively large clearances that can be achieved, the common practice for attempering vapor compressed by fans is to use a single attemperator nozzle upstream of the impeller. This system allows the flow compressed by the fan to be attempered, with obvious advantages for subsequent compression stages, which therefore process a fluid at a lower temperature. Furthermore, this attemperation system, compared to that typically used on compressors that use nozzles in the piping downstream of each stage, results in an increase in the power absorbed by the impeller, which increases the mass flow rate over which work can be transferred. Furthermore, it does not benefit from the evaporation of the liquid injected into the impeller itself, which does not occur due to the short residence times required to pass through it.

There is, therefore, a need for a steam compressor design solution that solves or at least mitigates the above-mentioned drawbacks.

### SUMMARY OF THE INVENTION

A purpose of the present invention is to improve the state of the art for steam compressors by means of an optimized architecture that minimizes the manufacturing cost, such that it makes it comparable to that of a fan, without compromising its typical performance.

The configuration described below features a compressor with a simple, lightweight, and cost-effective casing, similar to that used for fans, that does not directly support the impeller diaphragm, but is elastically connected to the same. The casing can therefore move a few millimeters relative to the diaphragm; the diaphragm, in turn, is rigidly mounted to the frame with suitable supports, without altering its clearance with respect to the impeller. The clearance can therefore be minimized to optimal values for thermodynamic performance, for example, to values of a few tenths of a millimeter.

According to another purpose, the invention proposes a particularly compact configuration that does not require particularly long interphase piping to meet the operating requirements of sprayer-attemperators installed according to the prior art. The configuration described in the present invention envisages a compressor with attemperators consisting of a plurality of sprayers that inject finely atomized water, with droplets smaller than 50 microns in diameter, into a “stilling chamber” built inside the casing and fluidically connected to the delivery pipe, which has a diameter significantly smaller than the casing. The possibility of mounting the sprayers in the casing with a diameter significantly larger than that of the pipe allows for the installation of a much greater number of nozzles for a given water flow rate, thus improving their atomization performance. It is known that the flow rate of a single spray nozzle is in fact proportional to the size of the droplets generated. A greater number of sprayers which realize a “fine” nebulization, i.e. with smaller diameter water droplets, allows for rapid evaporation with reduced residence times compared to a solution according to the known art.

Therefore, according to one aspect of the present invention, a steam compressor is described having the features set forth in the independent product claim appended to this description.

Further preferred and/or particularly advantageous embodiments of the aforementioned system are described according to the characteristics set forth in the appended dependent claims. These may also include compression systems with fluids other than water where similar attempering requirements exist, for example, the multistage compression of ammonia or low molecular weight fluids in general.

### BRIEF DESCRIPTION OF THE DRAWINGS

The invention will now be described with reference to the accompanying drawings in which:

FIG. 1 illustrates an example of a desuperheater according to the known art,

FIG. 2 illustrates a centrifugal compressor of the type with integrated multiplier, according to the known art,

FIG. 3 is an example of a centrifugal fan, according to the known art,

FIG. 4 illustrates a steam compressor with two centrifugal stages connected in series according to a preferred embodiment of the present invention, and

FIG. 5 is an enlarged detail of the compressor in FIG. 4.

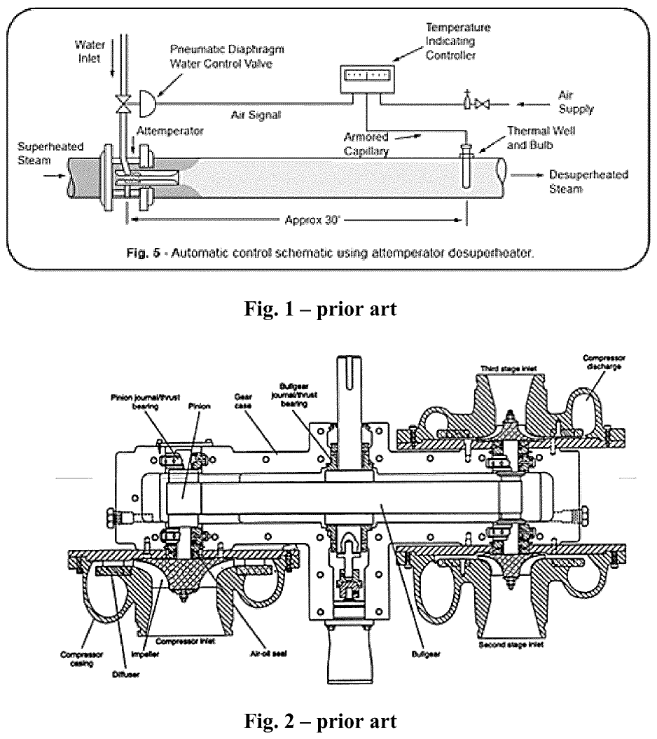

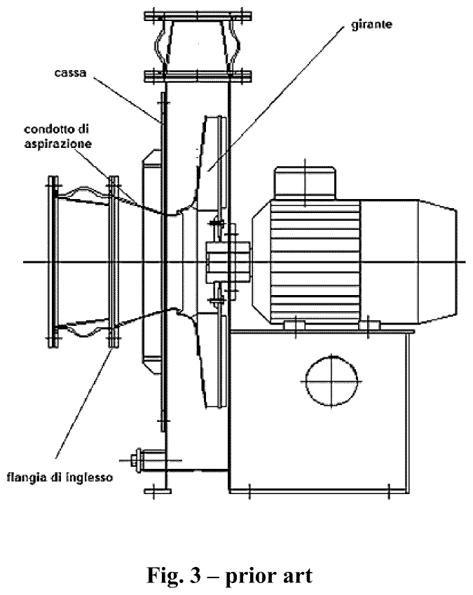

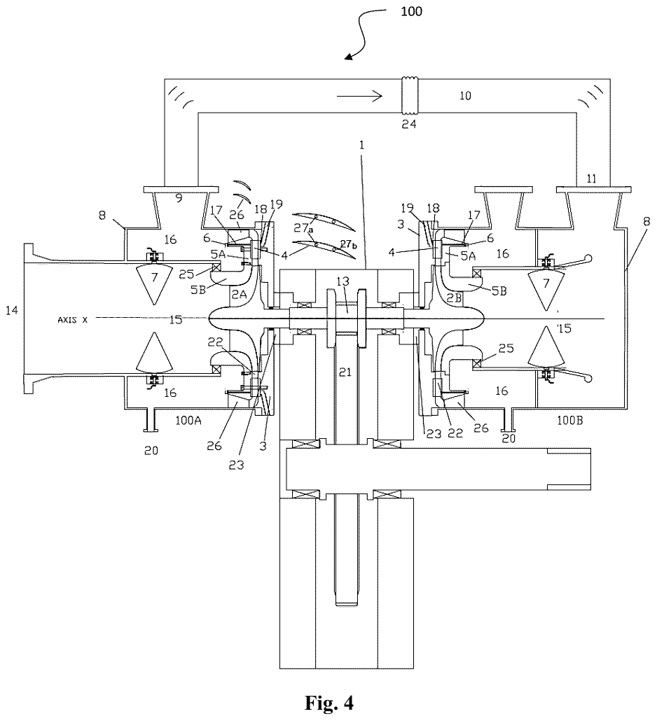

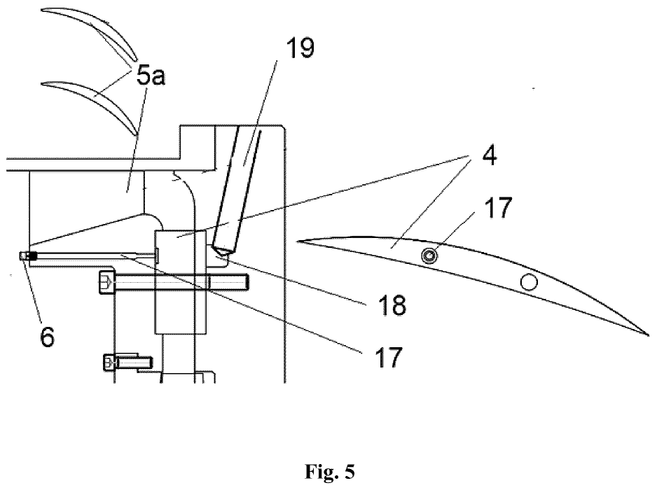

FIGS. 4 and 5 show on the same plane several sections of the machine, both meridian and transverse, to concisely highlight components that can be repeated cyclically around the axis of rotation. With the exception of FIGS. 1, 2, 3, the same numbers and reference letters in FIGS. 4 and 5 identify the same elements or components.

### DETAILED DESCRIPTION OF THE PREFERRED EMBODIMENTS

Referring to FIGS. 4 and 5, according to a preferred embodiment, a steam compressor 100 is provided with two centrifugal compression stages 100A, 100B, in series and driven by a gear multiplier with a single pinion, having an X-axis of rotation. The compressor 100 may be provided with a different number of compression stages, for example a single stage, without thereby departing from the scope of the present invention.

The compressor 100 includes:
a gear multiplier 1, made according to the known art, is equipped with a pinion 13, rotatable and mechanically connected to a wheel 21, which supports the impellers of the respective compression stages 100A and 100B, both fluidly connected by an interphase pipe 10;
at least one impeller 2A, 2B. In the exemplary form illustrated in FIG. 4, the impellers 2A, 2B are two in number and are suitable for compressing steam coming, respectively, from a first pipe with suction flange 14 with axial orientation and from a second pipe with suction flange 11 with radial orientation;
a first plate diaphragm 3 rigidly connected to the multiplier casing 1, acting as a rigid frame, with an interposed thermal barrier 23 made of insulating material, for example mica, to limit the transmission of heat from the diaphragm to the multiplier casing;
a second diaphragm 5A rigidly and fluidly connected to the first diaphragm 3 by screws passing through holes 27b made in the profile of compartments 4 inside a radial diffuser 22, with the compartments 4 incorporating one or more holes 27a inside the profile for the passage of water;
a third crown diaphragm 5 which also forms the impeller suction conveyor, is rigidly mounted on the diaphragm 5A according to the known art, creating a clearance of a few tenths of a millimeter near each impeller 2A, 2B to improve their fluid-dynamic efficiency;
a plurality of axially or diagonally developed rectifier compartments 26 mechanically connected to the diaphragm 5A which reduce the speed of the steam coming from the diffuser up to a speed of 30-60 m/s before entering a delivery plenum 16 so as to minimize the pressure drop in the latter component,
a plurality of water sprayers 6, suitably atomized with drops of diameter less than 50 microns, located downstream of the diaphragm 5A and downstream of the rectifier compartments 26, arranged circumferentially with respect to the axis X of the shaft and in proximity to the external diameter of the casing 8 and supplied by ducts 17 passing through the diaphragm 5A and the profile of the compartments 4 and in turn fluidly connected through the holes 27A to a circumferential distributor 18 supplied by one or more channels 19 for supplying the attempering water coming from a suitable external circuit;
a casing 8 elastically mounted with respect to the third diaphragm 5B, which is therefore free to expand in the axial and radial direction (indicatively by 1-2 mm) with respect to the diaphragm 5B, with at least one elastic element 25 interposed, for example a metal bellows or a flexible elastomeric ring, which guarantees the pneumatic seal between the suction duct 15 and the delivery plenum 16 fluidly connected to the outlet of the compartments 26 and to the sprayers 6;
the delivery plenum 16, possibly containing devices to convey the flow to minimize pressure drops, is fluidly connected to a delivery nozzle 9 which in turn is connected to the subsequent compression stage through an interphase pipe 10 possibly containing a thrust compensation system 24;
a radial or oblique suction nozzle 11, which conveys the flow into a casing 12, and a pre-rotation device IGV (“Inlet Guide Vanes”) 7. Therefore, the innovative architecture of the steam compressor 100 is characterized as follows:
   1) the attemperator sprayers 6 are mounted inside the compressor downstream of the impeller 2A, 2B and arranged circumferentially in the diffuser or immediately downstream of it on a circumference much larger than that of the pipe 10. This allows for the use of an optimized compressor design and the mounting of a greater number of sprayers than when installing them in a pipe. For the same total flow rate, a greater number of sprayers, for example from 10 to 30, allows for better atomization of the water, for example with average particle sizes less than 50 microns, with obvious advantages in terms of residence time for water evaporation, and therefore in the length of the interphase pipe, which can therefore have the minimum length necessary to connect the delivery nozzle 9 with the suction nozzle of the next phase 11 without the extra length needed to evaporate the injected water;
   2) the attemperator sprayers 6 are mounted inside the compressor at the inlet of the delivery plenum 16 or of an auger (not illustrated), thus exploiting the turbulent path and the long residence time that the steam travels in this component, induced by the larger cross-section, for example 50%, compared to that of the pipe, to completely vaporize the atomized water and therefore reduce the length of the interphase pipe 10. The low average speed of the steam in the discharge plenum, for example 10-20 m/s, favors the possible separation of liquid drops which are collected in a dedicated drain 20 in the lower part of the plenum without them being dragged into the pipe;
   3) the sprayers 6 are fed by one or more channels 19 which, with appropriate branches created inside the compressor, in the example illustrated the distributor 18, carry the tempering water to the sprayers 6. Preferably, a single channel 19 can be used for the water supply, so this simplifies the control of the water flow rate which is calculated as a function of the flow rate and conditions of the steam processed by the compressor;
4) the stator parts of the compression stage, the diaphragm 5A and the crown diaphragm 5B, are rigidly mounted to the casing of the multiplier 1, which supports the rotating parts, through the first plate diaphragm 3; the array of blades 26 downstream of the diffuser 22 reduces the average speed of the steam flow to a value close to that normally present in the plenum 16, for example between 10 and 20 m/s, in order to limit the pressure drops inside the plenum. The rectifier compartments can be made with a NACA profile produced by numerically controlled milling or with simple shaped and welded sheet metal. The compartments 26 can optionally be made as an extension of the profile of the compartments 4;
   5) the casing 8 of the compressor 100 is mounted elastically with respect to the stator parts 5B by means of suitable elastic elements 25, whether they are corrugated metal bellows or elastomers possibly “energized by steel springs”, which allow the movement of the casing, which therefore has no rigidity requirements with respect to the stator parts, while ensuring the pneumatic seal between zones at different pressure levels.

Therefore, the present invention solves some typical problems of steam compressors, in particular:
the erosion or in general the damage due to the presence of liquid at the compressor inlet if sprayers are used upstream of the impeller according to the known technique or in the case of tempering on the interphase pipe with excess liquid water entrained at the inlet of the impeller of the subsequent phase;
the complex and expensive design of the compressor casing. According to the invention, the compressor casing is lightweight and economical, has a small thickness and is made with minimal use of stainless steel, so that it does not have the rigidity constraints typical of traditional compressor casings;
the complexity of the piping system. According to the invention, the compressor piping system is compact and its length is not affected by the requirements associated with water injection of the attemperators: residence times for the water sprayed into the piping to completely evaporate and any need for separators (cyclones, mesh separators, etc.) needed to manage transients and failures related to the water injection control system.

Ultimately, the steam compressor according to the present invention is specifically optimized for the service of steam compression with attemperators and has indisputable advantages:
it is a more economical machine than compressors made according to the known technique with attemperators on the interphase pipes but with similar performances;
it is a machine with characteristics of simplicity and cost comparable to those of steam blowers (MVR blowers), which, however, are disadvantaged in terms of performance compared to a typical compressor due to the presence, among other things, of attemperators/sprayers upstream of the centrifugal impeller. This solution results in large clearances between the impeller and the stator, with consequent loss of efficiency and increased power due to the flow of attemperation water processed by the impeller.

In addition to the embodiments of the invention described above, it is to be understood that numerous further variations exist. It should also be understood that these embodiments are merely exemplary and do not limit the scope of the invention, its applications, or its possible configurations. Conversely, although the above description allows a skilled craftsman to implement the present invention at least according to one exemplary configuration, it is to be understood that numerous variations of the described components are conceivable, without departing from the scope of the invention, as defined in the appended claims.

1. A steam compressor (100), centrifugal, having one or more compression stages (100A, 100B) and comprising:
a gear multiplier (1) provided with a plurality of shafts (13) rotatable, with respect to a rotation axis (X),
at least one impeller (2A, 2B) supported by the shafts (13) and suitable for compressing steam coming from a pipe with a suction flange (14),
a first plate diaphragm (3) rigidly connected to the multiplier (1) with a thermal barrier (23) interposed to minimize the heat exchange,
a second (5A) and a third diaphragm (5B) rigidly and fluidically connected to the diaphragm (3) and in proximity to the at least one impeller (2A, 2B);
further comprising a casing (8) elastically mounted with respect to the third diaphragm (5B) and which is free to expand and move with respect to the third diaphragm (5B) by means of appropriate elastic elements (25) configured to ensure the seal between zones with different pressure levels.

2. The compressor (100) according to claim 1 comprising a plurality of atomized water sprayers (6), located downstream of the second (5A) and third diaphragm (5B) and downstream of the at least one impeller (2A, 2B), the plurality of atomized water sprayers (6) being arranged circumferentially with respect to the axis (X) and fed by ducts (17).

3. The compressor (100) according to claim 2, further comprising a circumferential distributor (18), fluidically connected to the ducts (17) and provided with one or more inlet channels (19) for the attempering water.

4. The compressor (100) according to claim 3, further comprising a plurality of compartments (4) rigidly connected to the first diaphragm (3) with one or more holes fluidically connected to the ducts (17) and to the distributor (18).

5. The compressor (100) according to claim 2, wherein the atomized water sprayer (6) are mounted inside a delivery plenum (16).

6. The compressor (100) according to claim 5, further comprising a plurality of rectifier compartments (26), upstream of the delivery plenum (16) and fluidically connected to the diffuser (22) of the at least one or more compression stages (100A, 100B).

7. The compressor (100) according to claim 6, wherein the delivery plenum (16) is fluidically connected to the outlet of the second (5A) and third diaphragm (5B) and to the atomized water sprayers (6) so as to create a calming chamber upstream of a delivery nozzle (9).

8. The compressor (100) according to claim 7, wherein the delivery plenum (16) is fluidically connected to a drain (20) to collect an excess of attempering water.

9. The compressor (100) according to claim 2, wherein the atomized water sprayers (6) are configured to inject water with finely distributed drops and having an average diameter of less than 50 microns.

10. The compressor (100) claims 1, further comprising a suction nozzle (11) with radial or diagonal orientation, i.e. not parallel to the rotation axis (X).
